(19) United States
(12) Patent Application Publication
(10) Pub. No.: US 2002/0170410 A1
(43) Pub. Date: Nov. 21, 2002

(54) Circular saw-blade with set and raker teeth

(76) Inventors: Hans-Jurgen Gittel, Rottenburg (DE); Dominique Fendeleur, Souffelweyersheim (FR); Gerhart Heusinkveld, Deventer (NL)

Correspondence Address: NATH & ASSOCIATES, 1030 15th STREET, 6TH FLOOR, WASHINGTON, DC, 20005, US

(21) Appl. No.: 09/929,284

(22) Filed: Aug. 15, 2001

(30) Foreign Application Priority Data
May 16, 2001 (DE) 101 23 752.9

(51) Int. Cl. B27B 33/08

(52) U.S. Cl. 83/835

(57) ABSTRACT

Disposed at the rim of a circular saw-blade (7) for parting wood, wood-based materials, plastics and non-ferrous metals are groups (4) of saw teeth, each group (4) comprising at least two set teeth in the form of staggered teeth (2,3), whereby the more remote radial end of at least two of the staggered teeth is provided with a bevel (9). Each group (4) of teeth comprises, in addition, one raker tooth (1) having a symmetrical cross-section.

### BACKGROUND DESCRIPTION

1. Field of the Invention

The present invention relates to a circular saw-blade for sawing wood, wood-based materials, plastics and non-ferrous metals as set forth in the preamble of claim 1.

In sawing materials such as wood, wood-based materials, plastics and non-ferrous metals the aim is to achieve high feed speeds for neat sawn edges and smooth sawn surfaces.

2. Prior Art

Circular saw-blades are known in a wealth of different types, the teeth thereof being configured differingly, depending on the application concerned. The shape of the teeth of the saw is especially important as regards the parting properties, a distinction thus being made among flat, trapezoidal, hollow-ground as well as staggered and roof-type teeth.

In addition, it is known to group the teeth in differing shapes. For example, in a roof/flat type group a roof-type tooth is followed by a somewhat shallower flat-type tooth. In a circular saw-blade having set teeth, the staggered teeth are disposed set right-hand and left-hand which may be bevelled for achieving better cutting results in such more sensitive materials as acrylic glass. Set teeth including a bevel are known, for example, from EP 0 691 170 B1.

Also known from WO 96/21545 is a saw-blade including groups of teeth each comprising six differing teeth, involving, for example, trapezoidal teeth. Since each tooth geometry needs to be ground separately, at least six grinding procedures are necessary in this case which makes producing this saw-blade very complicated.

The stability of circular saw-blades is basically low axially. Their specific pliancy is of the order of approx. 10 m/N and thus tooth deflection may be experienced even in the presence of relatively small axially forces, resulting in each tooth leaving an unsightly mark in the sawn finish. Apart from this, vibrations occur in the circular saw-blade which have a negative effect on flat and true running and result in a wavey finish and high noise emission.

It is known from DE 1 952 983 to dispose so-called roughing or planing teeth followed by so-called raker teeth within a group. German utility model GM 74 51 898 also describes groups of teeth each comprising a raker tooth and several roughing teeth.

### SUMMARY OF INVENTION

The invention is based on the objective of achieving a circular saw-blade for sawing materials such as wood, wood-based materials, plastics and non-ferrous metals with improved cutting quality and speed whilst achieving added useful life, i.e. enhanced resistance to wear.

This objective is achieved by a circular saw-blade as set forth in claim 1.

In accordance therewith, groups of saw teeth are disposed at the rim of a circular saw-blade, each group of saw teeth comprising at least two set teeth in the form of staggered teeth, whereby the more remote radial end of at least two of the staggered teeth is provided with a bevel. In addition, each group of teeth comprises one raker tooth having a symmetrical cross-section.

The bevelled staggered teeth thus have the configuration of radial asymmetrical roof-type teeth.

The bevelled set teeth of the circular saw-blade in accordance with the invention produce neat sawn edges as well as a smooth sawn surface area whilst the raker tooth handles clearing the kerf space and machines the middle portion of the kerf.

In this arrangement the bevelled set teeth and the raker tooth produce a kerf, the points of the set teeth protruding beyond the flat tooth on the right and left, the set teeth thus removing material only by their points. When the raker tooth is suitably configured, the cutting forces act in this case exclusively tangentially. Suitably configuring the set teeth results in the axially cutting force components totally canceling each other out, so that the group of teeth in accordance with the invention offers good guidance of the circular saw-blade. In addition, the low resulting axial forces reduce the wear of the saw teeth whilst minimizing the noise developed in sawing and preventing the circular saw-blade from vibrating due to any errors in sharpening.

Three different tooth geometries suffice for the circular saw-blade in accordance with the invention, making the production and repair of the raker tooth, in particular, a simple matter.

Circular saw-blades in accordance with the invention are excellently suitably for incorporating in low-power handheld machines and, for example, also in cordless machines, i.e. powered by rechargeable batteries.

The special configuration of the saw teeth enables the power requirement of the circular saw-blade to be significantly reduced and respectively permits achieving a higher feed speed to thus ultimately make for a higher machining power.

Advantageous further embodiments are set forth in the sub-claims.

Each group of teeth of the circular saw-blade in accordance with the invention comprises preferably two, four, six or eight set teeth in an alternating sequence of right-hand and left-hand staggered teeth, it being irrelevant whether a group commences with a right-hand or left-hand staggered tooth.

The raker tooth in this arrangement may be disposed at any position within the group, although it is preferably disposed at the start of each group in the cutting direction.

In one preferred embodiment of the circular saw-blade in accordance with the invention the set teeth comprise an axial angle. This offers the special advantage of the leading edge/corner first biting into the workpiece and facilitating removal of the chip debris along the slanted upright chip-forming surface.

The bevel angle of the set teeth may be in the range 10° to 60° and the width of the bevel is in the range of 5% to 40% of the tooth width.

It is furthermore preferred that the set teeth and/or the raker teeth of the circular saw-blade in accordance with the invention comprise a hollow-ground tooth front. In this case the raker tooth simultaneously bites into the material by its sharp cutting edges so that no forces occur which result in lateral deflection of the flat tooth. In conjunction with the set teeth the hollow-ground tooth front results in optimum cutting quality. Due to the hollow shape of the chip-forming surface the set tooth has a more pointed configuration at both the cutting corners and over the full cutting edge which facilitates the bite in thus requiring lower cutting forces and permitting a higher feed speed.

Disposed between the groups of teeth is preferably a chip space which is larger than the gullets between the individual saw teeth of a group. This larger chip space is able to receive a large amount of chip material in removing it from the kerf.

The raker tooth may be of any configuration as long as it comprises a symmetrical cross-section, and thus flat, trapezoidal, hollow-ground or roof-type teeth may be employed, for example, as raker teeth, it also being possible to make use of raker teeth having a facetted or cambered contour. In addition, differing raker teeth may also be provided in the various groups of teeth of a saw-blade.

In this arrangement, a hollow-ground tooth has the advantage that because of it being hollow-ground it is first the two points of the tooth that bite into the workpiece and stabilize the circular saw-blade. The trapezoidal and roof-type teeth have the advantage that they are axially force-neutralized and are guided in the workpiece by the point or narrow verge of the roof in thus stabilizing the saw-blade, this axially force-neutralized effect existing whenever symmetry to the body of the circular saw-blade is provided.

The set teeth are preferably configured somewhat wider than the raker tooth, i.e. side set by preferably approx. 0.3 mm. However, where the raker tooth comprises a cambered or facetted contour the raker tooth is configured preferably wider than the set teeth.

In one particularly advantageous aspect the points of the set teeth have the shape of an isoceles triangle in the projection, the axially cutting force components then being totally cancelled out, resulting in a particularly good guidance of the saw-blade in the kerf.

The raker tooth is always lower than the set teeth by preferably approx. 0.2 mm to 2 mm, this value corresponding to the selected middle chip thickness of the workpiece being worked.

By varying the protrusion of the raker tooth, the side set of the set teeth, the bevel angle/width of the set teeth, the width of the raker tooth as well as, where necessary, the axial angle, the saw-blade can be adapted to the material to be sawn, the desired cutting speed and feed.

### BRIEF DESCRIPTION OF THE DRAWINGS

The invention will now be detailed by way of example embodiments as shown in the drawings in which:

FIG. 1 is an illustration of a saw-blade in accordance with the invention showing the groups of teeth,

FIG. 2 is an illustration of a group of teeth in accordance with a first embodiment of the saw-blade in accordance with the invention,

FIG. 3 is an illustration of a group of teeth in accordance with a second embodiment of the saw-blade in accordance with the invention,

FIG. 4 is an illustration of four different possibilities of configuring a raker tooth of the saw-blade in accordance with the invention,

FIG. 5 is an illustration of two different set teeth and a raker tooth in accordance with a third (FIG. 5b) and fourth (FIG. 5c) embodiment of the saw-blade in accordance with the invention,

FIG. 6 is an illustration of two set teeth including a bevel and axial angle, and

FIG. 7 is a schematic view of a kerf produced by a saw-blade in accordance with the invention.

### DETAILED DESCRIPTION OF A PREFERRED EMBODIMENT

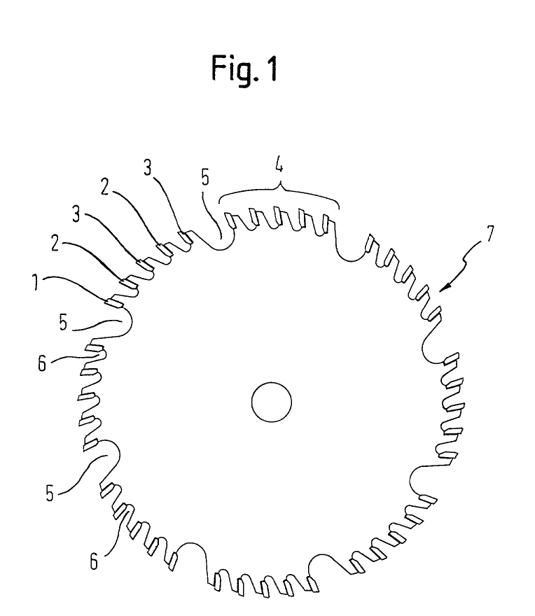

Referring now to FIG. 1 there is illustrated a preferred embodiment of a saw-blade 7 in accordance with the invention. Disposed at the rim of the saw-blade 7 are groups 4 of saw teeth. Each group 4 comprises, as viewed in the cutting direction, a raker tooth 1, a right-hand staggered tooth 2, a left-hand staggered tooth 3, a further right-hand staggered tooth 2 and a further left-hand staggered tooth 3 as detailed below. Provided between each two groups 4 is a chip space 5 taking up more of the rim of the saw-blade 7 than a gullet 6 between two individual teeth 1,2,3 of a group 4.

The set teeth 2,3 part the workpiece being sawn and produce neat sawn edges and a smooth sawn surface area on the workpiece. The raker tooth 1 machines the middle portion of the kerf and cleans the resulting space.

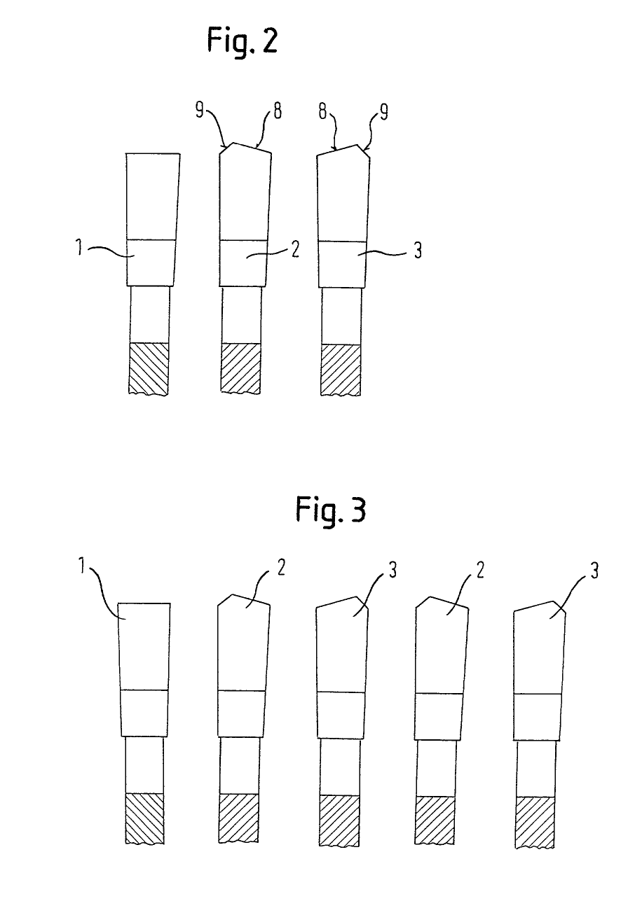

Referring now to FIG. 2 there is illustrated a first possibility of arranging the saw teeth within a group of teeth. In the example as shown, the group of teeth consists of a raker tooth 1, a right-hand staggered tooth 2 and a left-hand staggered tooth 3. The raker tooth 1 has a symmetrical cross-section and, in the case as shown, is a flat tooth. Both staggered teeth 2,3 are provided with a bevel 9 at the more remote radial end of their cutting edge 8.

Referring now to FIG. 3 there is illustrated a further possibility of arranging the saw teeth within a group of teeth. In this case, the group of teeth comprises a raker tooth as well as four set teeth 2,3, it being just as conceivable that groups of teeth comprising six or eight set teeth preferably adjoining the raker tooth within a group.

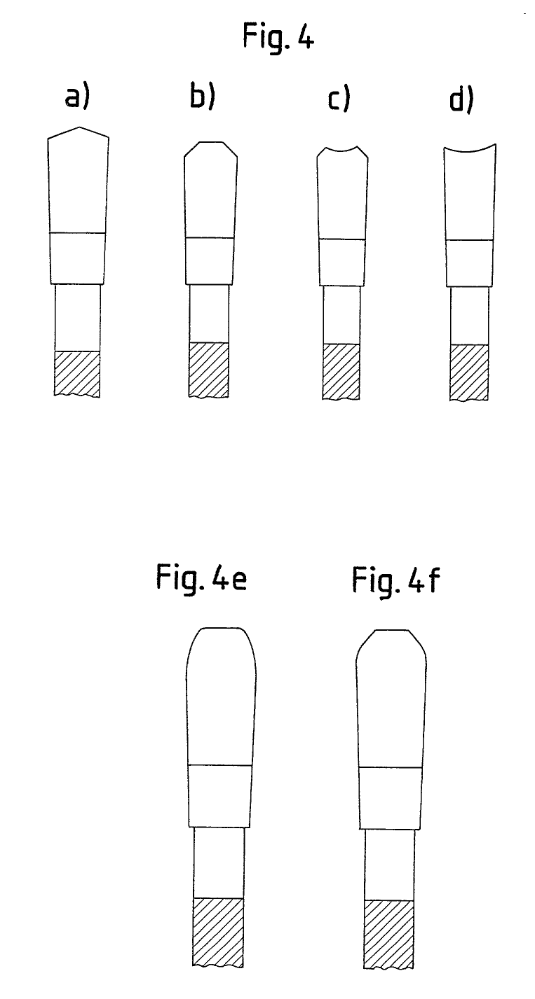

FIG. 4 illustrates various possible configurations of the raker tooth, FIG. 4a illustrating a roof-type tooth, FIG. 4b a bevelled hollow-ground tooth, FIG. 4c a trapezoidal tooth and FIG. 4d a hollow-ground tooth.

Referring now to FIG. 4e there is illustrated a flat tooth of cambered contour whilst FIG. 4f illustrates a flat tooth with facetted contour. In both cases the side facetted or curved contour commences at the crown and ends at the widest point of the tooth. In these two variants the raker tooth is wider than the set teeth by as much as 1 mm. These special tooth shapes have the advantage that the tooth on biting into the material scrapes the cutting edge by the rim cutters in removing only a thin chip in avoiding smearing of the sawn surface area and burr.

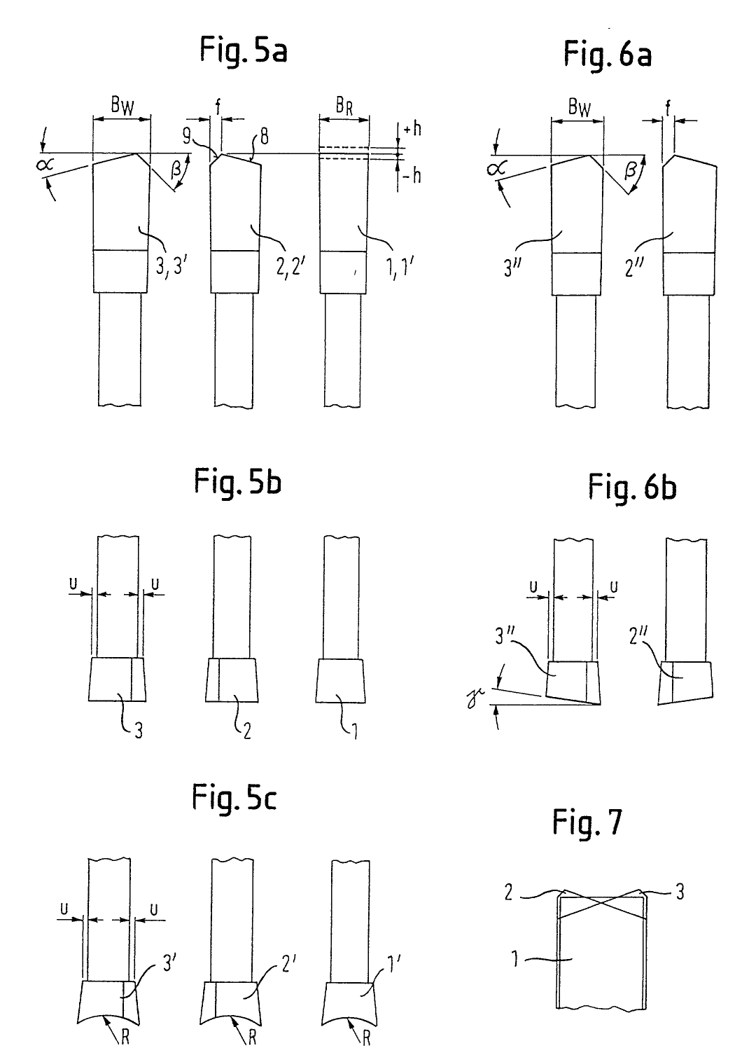

Referring now to FIG. 5 there are illustrated two set teeth 2, 3 and a raker tooth 1. It is evident from FIG. 5a that the cutting edges 8 of the set teeth 2,3 comprise a main angle of inclination a of preferably 15° as well as a bevel 9 having a width f angled β. This angle β is preferably 45°. Likewise evident from FIG. 5a is how the height of the cutting edge of the raker tooth 1 may be higher or lower than the outermost point of the set teeth 2, 3 by the amount h which is approx. 0.2 mm. The width Bw of the set teeth 2,3 is slightly wider than the width Br of the raker tooth 1.

FIG. 5b is a plan view of the set teeth 2,3 and raker tooth 1 as shown in FIG. 5a, whilst FIG. 5c is a plan view of a further embodiment of the saw teeth in accordance with the invention in which the set teeth 2′, 3′ and raker tooth 1′ have a hollow-ground front on the radius R. As explained above, the hollow-ground front results in optimum cutting quality due to the low cutting forces required and the resulting higher feed speed.

Referring now to FIG. 6 there is illustrated a further embodiment of the set teeth 2″, 3″ in accordance with the invention. As evident from the plan view in FIG. 6b the set teeth 2″, 3″ additionally comprise in this case an axial angle γ.

Referring now to FIG. 7 there is illustrated in conclusion diagrammatically the kerf produced by a saw-blade in accordance with the invention, The two set teeth 2, 3 and the raker tooth 1 of a group complement each other such that the outer contour of the kerf as shown in FIG. 7 materializes in which, as described above, the axial cutting force components fully cancel each other out.

1. A circular saw-blade (7) for parting wood, wood-based materials, plastics and non-ferrous metals at the rim of which groups (4) of saw teeth are disposed, each group comprising at least two set teeth in the form of staggered teeth (2,3), whereby the more remote radial end of the leading cutting edge (8) of at least two of said staggered teeth (2,3) is provided with a bevel wherein each group of teeth (4) comprises one raker tooth (1) having a symmetrical cross-section.

2. The circular saw-blade (7) as set forth in claim 1 wherein each group (4) of teeth comprises precisely two set teeth (2,3).

3. The circular saw-blade (7) as set forth in claim 1 wherein each group (4) of teeth comprises precisely four set teeth (2,3).

4. The circular saw-blade (7) as set forth in claim 1 wherein each group (4) of teeth comprises precisely six set teeth (2,3).

5. The circular saw-blade (7) as set forth in claim 1 wherein each group (4) of teeth comprises precisely eight set teeth (2,3).

6. The circular saw-blade (7) as set forth in any of the preceding claims wherein said raker tooth (1) is disposed at the start of each group (4) of teeth as viewed in the direction of cutting.

7. The circular saw-blade (7) as set forth in any of the preceding claims wherein said set teeth (2,3) comprise an axial angle (y)

8. The circular saw-blade (7) as set forth in any of the preceding claims wherein the bevel angle (β) of said set teeth (2,3) is in the range 10° to 60°.

9. The circular saw-blade (7) as set forth in any of the preceding claims wherein the bevel width (f) of said set teeth (2,3) is in the range 5 to 40% of the tooth width.

10. The circular saw-blade (7) as set forth in any of the preceding claims wherein said set teeth (2,3) and/or said raker tooth (1) comprise a hollow-ground front.

11. The circular saw-blade (7) as set forth in any of the preceding claims wherein each group (4) of teeth is separated from the other by a chip space (5) taking up a greater portion of the rim of said saw-blade (7) than the gullet (6) between two individual teeth (1,2,3) of a group (4).

12. The circular saw-blade (7) as set forth in any of the preceding claims wherein said raker tooth (1) is a flat, trapezoidal, hollow-ground or roof-type tooth.

13. The circular saw-blade (7) as set forth in any of the preceding claims wherein said set teeth (2,3) are roughly 0.2 to 2 mm wider than said raker tooth (1).

14. The circular saw-blade (7) as set forth in any of the claims 1 to 12 wherein said raker tooth (1) comprises a cambered or facetted contour.

15. The circular saw-blade (7) as set forth in claim 14 wherein said raker tooth (1) is wider by approx. 0.1 to 2 mm than said set teeth (2,3).

16. The circular saw-blade (7) as set forth in any of the preceding claims wherein the points of said set teeth (2,3) have the shape of an isosceles triangle in the projection.

17. The circular saw-blade (7) as set forth in any of the preceding claims wherein said raker tooth (1) is roughly 0.2 to 2 mm lower than said set teeth (2,3).
